(19) United States
(12) Patent Application Publication
(10) Pub. No.: US 2012/0011330 A1
(43) Pub. Date: Jan. 12, 2012

(54) MEMORY MANAGEMENT APPARATUS, MEMORY MANAGEMENT METHOD, PROGRAM THEREFOR

(75) Inventors: Yasuhiro MATSUZAKI, Tokyo (JP); Hiroki KAMINAGA, Kanagawa (JP); Kazuhito NARITA, Tokyo (JP); Kazumi SATO, Kanagawa (JP)

(73) Assignee: Sony Corporation, Tokyo (JP)

(21) Appl. No.: 13/116,393

(22) Filed: May 26, 2011

(30) Foreign Application Priority Data
Jul. 10, 2010 (JP) 2010-150846

(51) Int. Cl. G06F 12/00

(52) U.S. Cl. 711/154; 711/E12.001

(57) ABSTRACT

Provided is a memory management apparatus including a determiner configured to determine whether or not a pattern of writing data being data to be a target of an instruction of writing in a memory is a frequently-appearing pattern, and a setting unit configured to set a shared reference with respect to the writing data having the frequently-appearing pattern in a case where it is determined by the determiner that the pattern of the writing data is the frequently-appearing pattern and data of the frequently-appearing pattern has already been held in the memory.

### BACKGROUND

The present disclosure relates to a memory management apparatus, a memory management method, and a program therefor, which manage data in a memory of a computer.

In a Copy-On-Write mechanism, for example, at the time of generation of a child process, a physical memory area is allocated only for pages that may be rewritten, and a shared reference is made on physical pages of its parent process for pages that may not be rewritten. Then, at the time of writing, a physical memory area for all data of the child process is allocated for the first time, and a copying is executed.

By the way, in an application program, it is often expected that zero data be written in a memory in an initial state. In this case, when an operating system uses the above-mentioned Copy-On-Write mechanism, a shared reference can be made on a zero page (all data in the page is constituted of zero data), which increases efficiency.

In addition to the Copy-On-Write mechanism, there has been a system of sharing the same data. For example, in a method described in Japanese Patent Application Laid-open No. 2009-543198 (hereinafter, referred to as Patent Document 1), a module searches for the same data by using a hash (fingerprint) of a data block, so that the sharing is attempted.

### summary

However, even when the Copy-On-Write mechanism is used in the above-mentioned manner, the following problem has occurred. For example, in the case where it is expected that zero data be written in a memory, most of application software performs, by itself, a process of filling a plurality of pages thereof with zeros at the time of startup. Therefore, due to this, the Copy-On-Write mechanism does not work effectively, which causes a problem that zero pages are largely increased.

On the other hand, in the system using the hash as in the method of Patent Document 1, a process of computing the hash value is expensive. A process of searching for the same hash data is also expensive, and hence it is difficult to apply this method to a calculator having low processing capability, for example.

In view of the above-mentioned circumstances, there is a need for providing a memory management apparatus, a memory management method, and a program therefor, which are capable of suppressing a large amount of pages each having a frequently-appearing pattern such as zero pages or the like from being accumulated in a memory without the need of high computing processing capability.

According to an embodiment of the present disclosure, there is provided a memory management apparatus includes a determiner and a setting unit.

The determiner determines whether or not a pattern of writing data being data to be a target of an instruction of writing in a memory is a frequently-appearing pattern.

The setting unit sets a shared reference with respect to the writing data having the frequently-appearing pattern in a case where it is determined by the determiner that the pattern of the writing data is the frequently-appearing pattern and data of the frequently-appearing pattern has already been held in the memory.

In the embodiment of the present disclosure, in the case where the pattern of the writing data is the frequently-appearing pattern, if the writing data has already been held in the memory, the shared reference is set with respect to the subsequent data having this frequently-appearing pattern. Thus, it is possible to suppress a large amount of data having the frequently-appearing pattern from being accumulated in the memory. In addition, in a process of the embodiment of the present disclosure, hash data is not used, and hence high computing processing capability is unnecessary.

The frequently-appearing pattern may be a pattern in which a predetermined number of pieces of data having the same value are continuous. Alternatively, the frequently-appearing pattern may be a pattern accumulated by learning of a computer, or the frequently-appearing pattern may be a data pattern of a copying source.

The determiner may determine whether or not the pattern of the writing data is the frequently-appearing pattern on a basis of whether or not the pattern of the writing data corresponds to the frequently-appearing pattern defined in advance.

According to an embodiment of the present disclosure, there is provided a memory management method by a memory management apparatus, the method including determining whether or not a pattern of writing data being data to be a target of an instruction of writing in a memory is a frequently-appearing pattern.

A shared reference is set with respect to the writing data having the frequently-appearing pattern in a case where it is determined that the pattern of the writing data is the frequently-appearing pattern and data of the frequently-appearing pattern has already been held in the memory.

According to an embodiment of the present disclosure, there is provided a program causing a memory management apparatus to execute the above-mentioned memory management method

As described above, according to the embodiments of the present disclosure, it is possible to suppress a large amount of pages each having a frequently-appearing pattern of zero pages or the like from being accumulated in a memory without the need of high computing processing capability.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a configuration of a system for realizing a memory management apparatus according to an embodiment of the present disclosure;

FIG. 2 is a flowchart showing processes by the memory management apparatus;

FIG. 3 is a flowchart showing a process at Step 102 in FIG. 2;

FIG. 4 is a flowchart showing a process at Step 104 in FIG. 2;

FIGS. 5 are view each showing a logical image and a physical memory block of writing data, which show an example in which a pattern of a zero page becomes a frequently-appearing pattern; and

FIGS. 6 are view each showing a logical image and a physical memory block of writing data, which show an example in which a data pattern of a copying source becomes the frequently-appearing pattern.

### DETAILED DESCRIPTION OF EMBODIMENTS

Hereinafter, an embodiment of the present disclosure will be described with reference to the drawings.

[Configuration for Realizing Memory Management Apparatus]

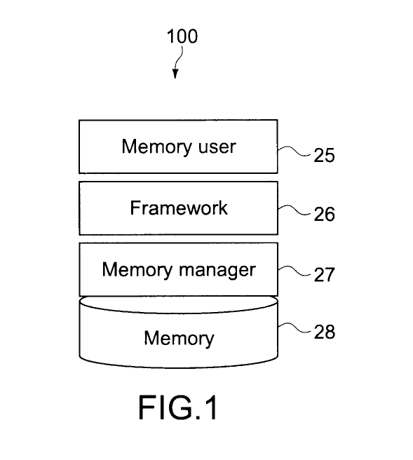

FIG. 1 is a block diagram showing a configuration of a system for realizing a memory management apparatus according to an embodiment of the present disclosure. This system 100 is constituted of hardware and software, which are implemented on a computer, and includes a memory 28, a memory manager 27, a framework 26, and a memory user 25.

The above-mentioned computer includes, although not shown, a Central Processing Unit (CPU), a Random Access Memory (RAM), a Read Only Memory (ROM), and publicly known hardware resource such as an auxiliary storage unit. Here, although the memory 28 corresponds mainly to the RAM, the RAM and the auxiliary storage unit can be also considered as one virtual storage by the use of a technology of a virtual memory of a publicly known Operating System (OS).

In the following, when the “memory” is simply described, it refers basically to the physical memory. However, when the logical memory and the physical memory are collectively represented, or for the sake of understanding the technique of this embodiment, it may refer to any of the logical memory and the physical memory. However, when simply describing the “memory” makes understanding difficult, it will be described as the “physical” memory or the “logical” memory, distinctly.

The memory user 25 requests to allocate the memory 28 (allocate physical memory 28) and to read and write it in reality. Here, in the case where the memory manager is a garbage collector or a host OS of a virtual computer as will be described later, the “memory” in the context of “allocating of the memory” is not the “physical memory” in a strict sense.

Upon receipt of the instruction from the memory user 25, the framework 26 performs processes of copying and writing data on the memory 28.

The memory manager 27 manages the memory 28, and intermediate the reading and writing between the memory 28 and the framework 26.

A specific example of a configuration of this system 100 includes a configuration in which the memory user 25 is application software (hereinafter, abbreviated as application), the framework 26 is a standard library, and the memory manager 27 is an OS.

In addition to this, there is a configuration in which the memory user 25 is the application and the memory manager 27 is the garbage collector. Alternatively, there is exemplified a configuration in which the memory user 25 is a guest OS in the virtual computer, the framework 26 is a virtual machine, and the memory manager 27 is the host OS.

In such a configuration, as will be described later, the framework 26 determines the writing process, and transmits to the memory manager 27 an instruction for the shared reference.

### [Process by Memory Management Apparatus]

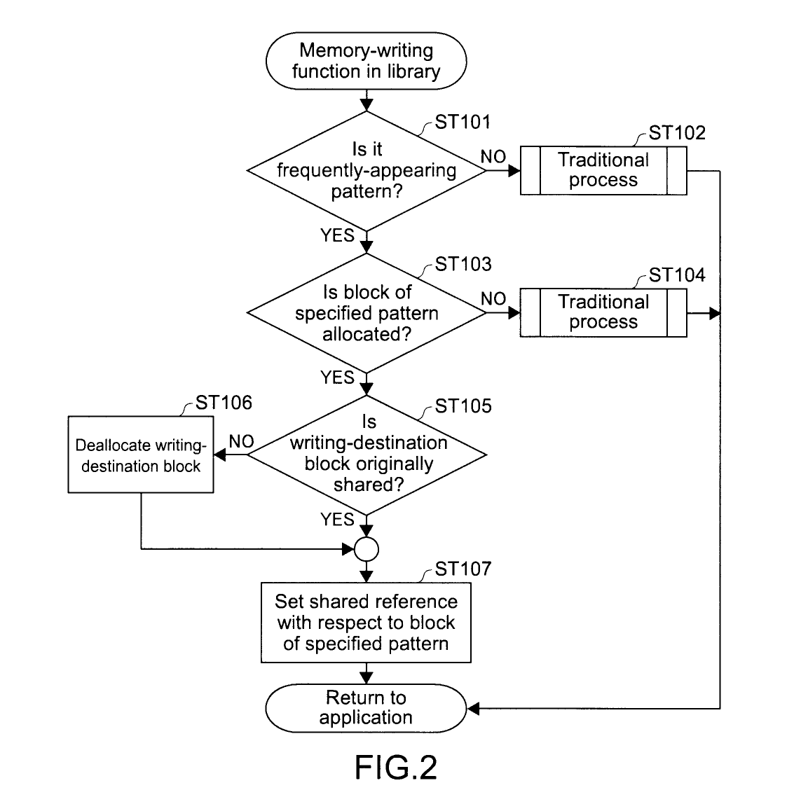

FIGS. 2 to 4 are flowcharts showing processes by the memory management apparatus. The following process by the memory management apparatus is realized by cooperation of the software stored in the ROM or the auxiliary storage unit and the above-mentioned hardware resource. In addition, in the description of those flowcharts, an example in which an application is used as the memory user 25, a standard C library is used as the framework 26, and a Linux kernel is used as the memory manager 27 will be described. The processes of those flowcharts are repeatedly performed in block size units of the physical memory 28 as will be described later.

First, the application calls functions to be written in the memory 28 of the standard C library (hereinafter, abbreviated as library). Specifically, the application and the library specify a logical block address of writing destination of the memory 28, and a physical block address is specified through the memory manager 27.

The library determines whether or not a pattern of writing data being data to be a target of the instruction of writing in the memory 28 is a frequently-appearing pattern (Step 101). At this time, the CPU and the library function as a determination means for executing the determination process.

Here, for example, in a paging, the block size corresponds to a page unit being a unit of the writing size at the time of writing data, and is typically 4 KB.

Here, the frequently-appearing pattern is a pattern of data having one block size of the physical memory 28, and a pattern defined in the following manner.

For example, at Step 101, in a function memset writing fixed values, whether or not each of the fixed values is a frequently-appearing value is checked. The fixed value is, for example, 00 value, FF value, FE value, or the like in a case of employing hexadecimal. That is, in this case, a data pattern in which all values in one block are fixed value is considered as the frequently-appearing pattern. Actually, at Step 101, it is sufficient that whether or not the fixed value is the frequently-appearing value and whether or not the data size constituted of the continuous frequently-appearing values is equal to or larger than the block size, that is, the size of one block, of the memory 28 be determined.

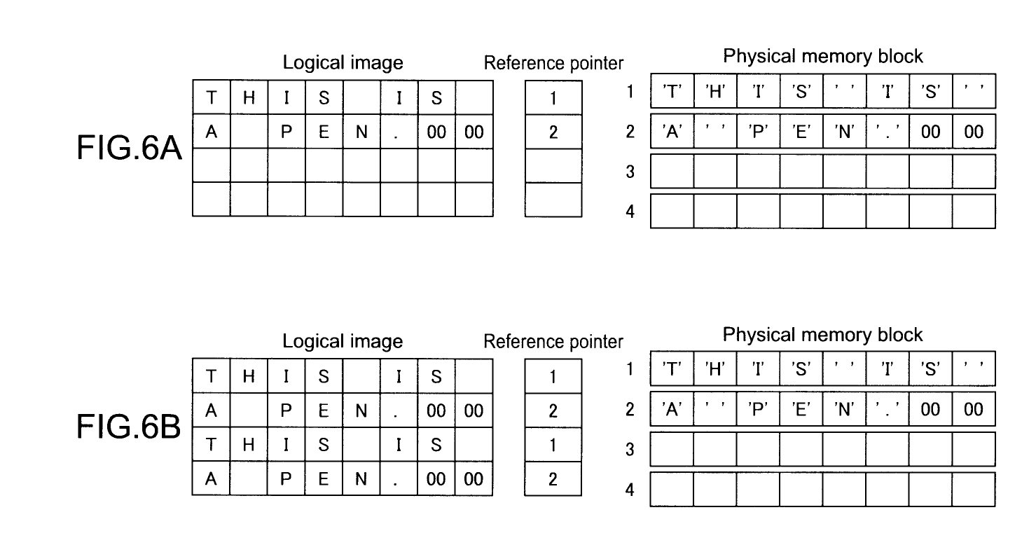

Alternatively, as an example of the frequently-appearing pattern, in a memory-copying function memcpy, a data pattern of the copying source is considered as the frequently-appearing pattern. That is, as will be described later with reference to FIGS. 6A and 6B, it refers to a data pattern having the same content in the case where a request of writing data having the same content as that of data that was written in the past is again provided.

As described above, as the frequently-appearing pattern, a pattern expected to frequently appear is typically defined in advance.

Rather than defining in advance the frequently-appearing pattern, the frequently-appearing pattern may be defined by learning of the computer. For example, there is a method in which, in the case where information of the writing data at Step 101 is accumulated (is subjected to profiling), and the number of requests of writing information having the same content is larger than a threshold value, the pattern of this writing data is set as the frequently-appearing pattern. In addition, publicly known various methods can be employed as a learning method.

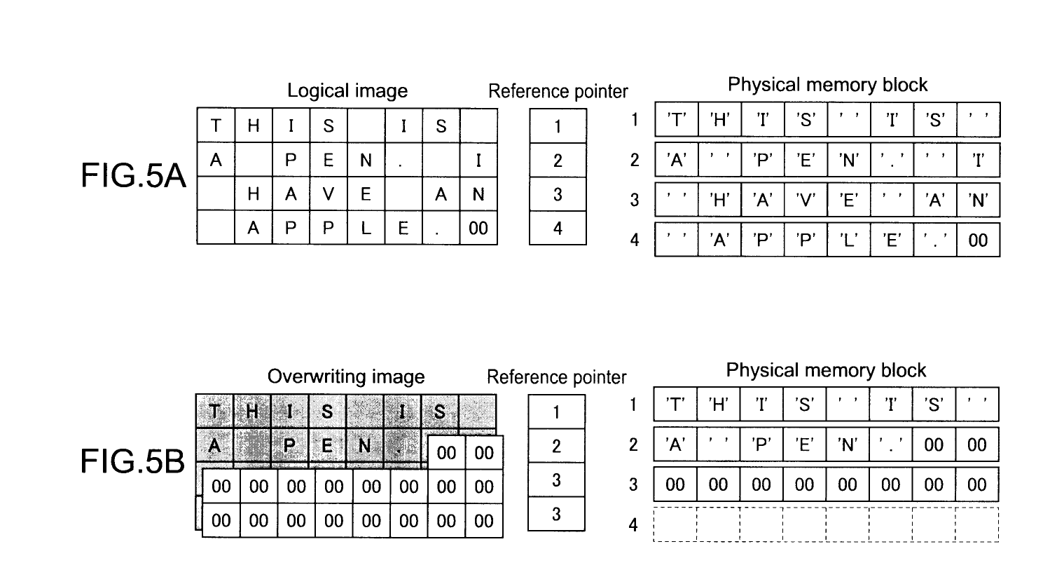

Here, Steps 101, 103 and 105 to 107 of the flowchart of FIG. 2 will be described with reference to FIGS. 5A and 5B. FIG. 5A shows a block and a logical image thereof in the physical memory 28 before the writing data is written, and further, a view between them shows reference pointers of the memory blocks. This example in FIG. 5A shows four blocks, and different data is held in each of the four blocks.

FIG. 5B is a view showing a state of a memory when the writing (overwriting) of the writing data is performed on the memory shown in FIG. 5A. As an example of the “writing data” of FIG. 5B, data for three blocks is shown, where some values in a second block, and all values in third and fourth blocks are 00 values. Thus, the data pattern of the second block is not the frequently-appearing pattern, and each of the data patterns of the third and fourth blocks is the frequently-appearing pattern. It should be noted that, as described above, the process of FIG. 2 is repeatedly performed in block units.

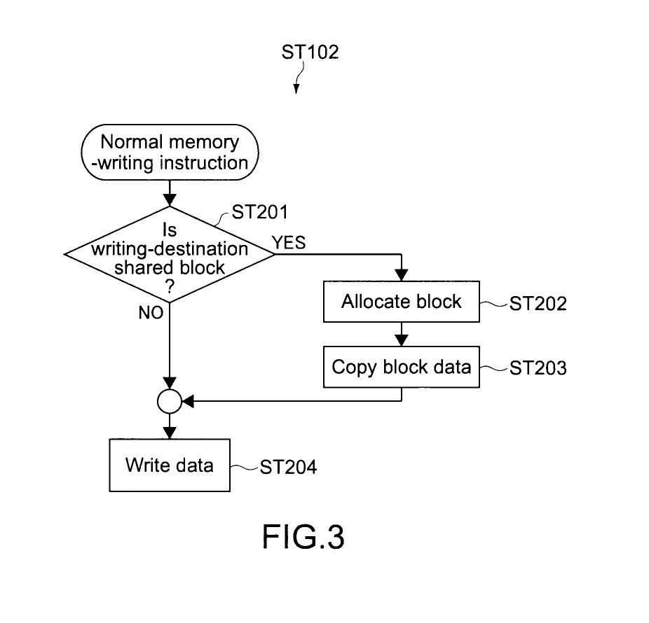

At Step 101, for example, in the case where the pattern of the writing data is not the frequently-appearing pattern as in the second block in the overwriting image in FIG. 5B, a traditional method is used to perform the writing in the memory 28 (Step 102). After that, the process returns to the application. FIG. 3 is a flowchart showing the content of this Step 102, that is, a traditional process.

In FIG. 3, first, whether or not a memory block (hereinafter, abbreviated as block) specified as the writing destination of the writing data is a sharing block is determined (Step 201). Typically, the sharing block is a block to be a target, on which a shared reference to be made, in the case where the physical memory 28 is shared during a plurality of processes. In the case where a block of the writing destination is the sharing block, the writing on such a block is forbidden, and hence a new block of the memory 28 is allocated (Step 202). Then, as shown in the second block of the physical memory block of FIG. 5B, data of that block is copied (Step 203), and the writing of the writing data is executed (Step 204). At this time, the writing data requested by the application may be data of a part of one block.

The rest of the flowchart of FIG. 2 will be described. At Step 101, in the case where it is determined that the pattern of the writing data is the frequently-appearing pattern (as in third block in the example of FIG. 5B), the following process is executed. Whether or not a block having the data of the same content as that of the data of a pattern (hereinafter, referred to as specified pattern) corresponding to the frequently-appearing pattern is allocated in the entire writing data (here, data over one block size) is determined (Step 103). In other words, whether or not the data of the specified pattern has already been held in the physical memory 28 is determined. In the case of the example of the third block of FIG. 5B, the specified pattern being its block pattern (zero page being page all filled with 00 values) has not yet been held in the memory 28 (NO at Step 103), and hence the traditional process is performed (Step 104).

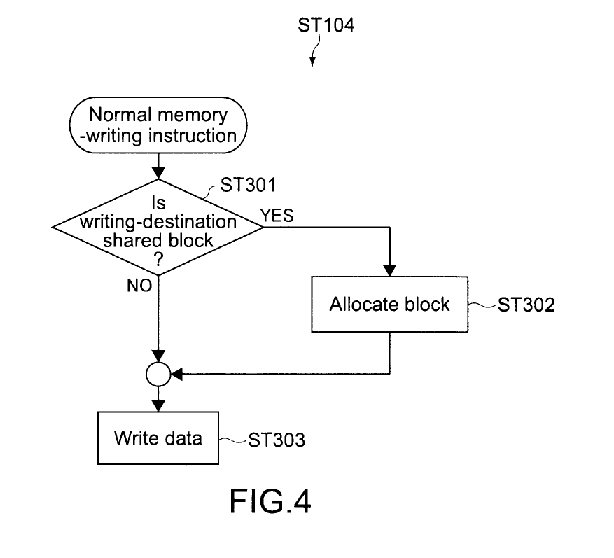

FIG. 4 is a flowchart showing the process of this Step 104. This process is basically the same as the process shown in FIG. 3, but is different from the process shown in FIG. 3 in that there is not Step 203 of FIG. 3. At Step 101, the pattern of the writing data is determined to be the frequently-appearing pattern, and it is ensured that all data in one block are overwritten with the data of the frequently-appearing pattern, and hence the copying of the block data becomes unnecessary. However, depending on the implementation of the memory manager, the copying of the data may be performed.

On the other hand, in the case of the example of the fourth block of the overwriting image of FIG. 5B, the process proceeds to Steps 101, 102, and 103, and, at Step 103, YES determination is made. That is, in the example of the fourth block, in the process with respect to the third block, the block of the specified pattern has already been allocated, and hence YES determination is made, and the process proceeds to Step 105.

At Step 105, whether or not the block specified as the writing destination is originally the sharing block is determined. “Originally” means, for example, as shown in FIG. 5A, a point in time before the writing data is written. In the example of the FIGS. 5A and 5B, in the case where the fourth block is not originally the sharing block (NO at Step 103), the processing on the fourth block becomes free and unnecessary, and hence the fourth block is deallocated (Step 106). Then, with respect to the third block having its specified pattern, the shared reference is set (Step 107). In FIG. 5B, the deallocated fourth block is indicated by a broken line.

It should be noted that the deallocation of the block, the setting of the shared reference, and the like are executed by the Linux kernel, and the CPU and the Linux kernel function as a setting means for the shared reference.

On the other hand, in the case where Yes determination is made at Step 105, the setting of the shared reference is kept (Step 107).

FIGS. 6A and 6B show another example of the writing data. This example shows a mode in which data is copied, and is an example in which as shown in the logical images of FIGS. 6A and 6B, the data of the first and second blocks is copied. The data pattern of each of the first and second blocks being the copying sources is considered as the frequently-appearing pattern. According to the processes shown in FIG. 2, the shared reference is set with respect to the first and second blocks, and the third and fourth blocks are set as free space.

As described above, in this embodiment, in the case where the pattern of the writing data is the frequently-appearing pattern, if the writing data has already been held in the memory 28, the shared reference is set with respect to the subsequent writing data having this frequently-appearing pattern. In this manner, it is possible to suppress a large amount of data having the frequently-appearing pattern from being accumulated in the memory 28. Thus, free space in the memory 28 is increased, and hence the memory 28 can be efficiently used.

The inventors actually carried out an experiment of a memory management, using the system 100. As a result of this experiment, in comparison with the related art, an effect that zero data was reduced by about 13% was confirmed in this embodiment.

In addition, in the processes of this embodiment, for example, in Steps 103 to 105, the process of writing the block having the same data can be omitted, and hence the processing speed is increased. In addition, a shared reference is made on the block of the data of the same content, and hence hit ratio of data cash of the CPU is also increased.

Further, in this embodiment, the hash data is not used unlike the related art, and hence high computing processing capability is unnecessary.

In particular, in view of the fact that most of applications fills all of the allocated blocks with zero pages after the blocks are allocated, the system 100 works effectively on such applications.

In this embodiment, as described above, the library executes the determination process at Step 101, and hence the determination process and the search for blocks holding the same data become easy. In addition, it is unnecessary to change programs of the memory user such as applications for realizing the system 100.

The embodiments according to the present disclosure are not limited to the above-mentioned embodiment, and other various embodiments of the present disclosure can be made without departing from the gist of the present disclosure.

The present disclosure contains subject matter related to that disclosed in Japanese Priority Patent Application JP 2010-150846 filed in the Japan Patent Office on 1 Jul. 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A memory management apparatus, comprising:
a determiner configured to determine whether or not a pattern of writing data being data to be a target of an instruction of writing in a memory is a frequently-appearing pattern; and
a setting unit configured to set a shared reference with respect to the writing data having the frequently-appearing pattern in a case where it is determined by the determiner that the pattern of the writing data is the frequently-appearing pattern and data of the frequently-appearing pattern has already been held in the memory.

2. The memory management apparatus according to claim 1, wherein the frequently-appearing pattern is a pattern in which a predetermined number of pieces of data having the same value are continuous.

3. The memory management apparatus according to claim 1, wherein the frequently-appearing pattern is a pattern accumulated by learning of a computer.

4. The memory management apparatus according to claim 1, wherein the frequently-appearing pattern is a data pattern of a copying source.

5. The memory management apparatus according to claim 1, wherein the determiner determines whether or not the pattern of the writing data is the frequently-appearing pattern on a basis of whether or not the pattern of the writing data corresponds to the frequently-appearing pattern defined in advance.

6. A memory management method by a memory management apparatus, comprising:
determining whether or not a pattern of writing data being data to be a target of an instruction of writing in a memory is a frequently-appearing pattern by a determination means; and
setting a shared reference with respect to the writing data having the frequently-appearing pattern in a case where it is determined that the pattern of the writing data is the frequently-appearing pattern and data of the frequently-appearing pattern has already been held in the memory by a setting means.

7. A program causing a memory management apparatus to execute:
determine whether or not a pattern of writing data being data to be a target of an instruction of writing in a memory is a frequently-appearing pattern by a determination means; and
set a shared reference with respect to the writing data having the frequently-appearing pattern in a case where it is determined that the pattern of the writing data is the frequently-appearing pattern and data of the frequently-appearing pattern has already been held in the memory by a setting means.
